(19) United States
(12) Patent Application Publication
(10) Pub. No.: US 2011/0277723 A1
(43) Pub. Date: Nov. 17, 2011

(54) CYLINDER HEAD FOR AN INTERNAL COMBUSTION ENGINE, WITH INTEGRATED EXHAUST MANIFOLD

(76) Inventors: Giampaolo GALEAZZI, Torino (IT); Antonio Abozzi, Torino (IT)

(21) Appl. No.: 13/048,991

(22) Filed: Mar. 16, 2011

(30) Foreign Application Priority Data
May 17, 2010 (EP) 10425161.6

(51) Int. Cl. F02F 1/42

(52) U.S. Cl. 123/193.5

(57) ABSTRACT

A cylinder head for an internal combustion engine incorporates—in a single cast piece—the engine exhaust manifold. A lower cooling jacket and an upper cooling jacket arranged below and above said integrated exhaust manifold are provided in the body of the head. At least one of such cooling jackets is divided into separate transverse chambers by partitions extending transverse with respect to the longitudinal direction of the head, so that the cooling fluid is forced to traverse such transverse chambers parallel according to the direction orthogonal to the longitudinal direction of the head.

### FIELD OF THE INVENTION

The present invention refers to a cylinder head for internal combustion engines of the type indicated in the preamble of claim 1.

Cylinder heads are also known, having:
a body with an upper face, a lower face, two end faces and two lateral faces,
said body integrating, in a single cast piece, the engine exhaust manifold,
said exhaust manifold being defined by a plurality of passages for the exhaust gases provided in the body of the head, all said passages converging into a common outlet ending in a lateral face of the head, and
at least one lower cooling jacket and at least one upper cooling jacket provided in the body of the head, substantially below and above passages defining the exhaust manifold.

### PRIOR ART

A cylinder head of the type indicated in the preamble of claim 1 is known from US 2004/173168 A1.

Cylinder heads of the previously specified type integrating the exhaust manifold have been known over the years. A cylinder head of this type, in particular intended for a turbocharged internal combustion engine, is described in document U.S. Pat. No. 4,993,227.

The integration of the exhaust manifold in the cylinder head allows a construction simplification and also a reduction of the manufacturing costs, given that in the conventional engines with separate exhaust manifold the latter must be made of precious steel to bear the high operating temperatures, while in the cylinder heads with integrated manifold the material constituting the head and the manifold is typically aluminium, and the problems deriving from the high temperatures of the exhaust gases is resolved by providing a liquid cooling for the manifold and the head, through the abovementioned cooling jackets.

As previously indicated, document U.S. Pat. No. 4,993,227 shows a solution of this type used for a turbocharged engine, in which the integration of the exhaust manifold in the head allows mounting a compressor unit on the face of the head on which the abovementioned common outlet of the exhaust gases ends. In the abovementioned prior art solution, the lower cooling jacket receives a cooling fluid coming from passages provided in the engine block through a plurality of access openings provided on the lower face of the head and distributed along the entire longitudinal dimension of the head. The cooling fluid is distributed freely in the lower cooling jacket over the entire longitudinal dimension thereof and then reaches the upper jacket through a plurality of passages, also distributed along the entire longitudinal direction of the head. In the upper cooling jacket the fluid is also distributed freely through the entire longitudinal dimension of the head until it converges together with the fluid which passes through the lower cooling jacket into an outlet provided adjacent to an end of the head.

A substantially similar solution is also described in document US2009/0126659A1. The only substantial difference between the solution described in such second document and the one described in U.S. Pat. No. 4,993,227 lies in the fact that in the case of such second document the lower cooling jacket and the upper cooling jacket are substantially separated from each other over the entire longitudinal dimension of the head and they receive the cooling liquid mainly from inlet openings arranged at an end of the head, so that the cooling liquid passes through the two lower and upper cooling jackets along the entire longitudinal direction and then exiting through an opening provided at the opposite end of the head, which is in communication with both the cooling jackets.

A drawback of the previously described prior art solutions lies in the fact that the lower and upper cooling jackets are substantially traversed each by a longitudinal flow of a cooling fluid, from one end to the other of the head, which does not guarantee an ideal and uniform cooling of all the portions of the head associated to the cylinders of the engine.

### OBJECT OF THE INVENTION

The object of the present invention is that of providing a cylinder head of the type indicated at the beginning of the present description where the abovementioned drawback is overcome and particularly where an optimal and uniform cooling of the portions of the head is guaranteed and in particular the cooling of the portions of the exhaust manifold, associated to the various cylinders of the engine.

### SUMMARY OF THE INVENTION

According to the invention, such object is attained due to the features of claim 1. Due to such characteristic, the head according to the invention ensures that the cooling fluid does not traverse the abovementioned cooling jackets longitudinally from one end of the head to the other, but it is forced at least partly to flow according to directions transverse to the longitudinal direction of the head, parallel in the various cooling chambers associated to the various cylinders of the engine, hence ensuring correct translation velocity of the cooling fluid, as well as—above all—a substantial cooling uniformity between the various portions of the cylinder head, and in particular of the exhaust manifold, associated to the various cylinders of the engine.

### BRIEF DESCRIPTION OF THE DRAWINGS

Now, the invention shall be described referring to a preferred embodiment, illustrated purely by way of non limiting example, wherein:

FIG. 1 is a perspective view of a cylinder head according to the invention,

FIG. 2 is a plan view of the cylinder head of FIG. 1,

FIG. 3 is a side view of the head of FIGS. 1, 2,

FIG. 4 is a sectional view according to line IV-IV of FIG. 3,

FIG. 5 is a sectional view according to line V-V of FIG. 4,

FIG. 6 is a sectional view according to line VI-VI of FIG. 4,

FIGS. 7, 8, 9 are sectional views according to lines VII-VII, VIII-VIII and IX-IX of FIG. 6,

FIG. 10 is an exploded perspective view of the cores used for providing the passage of the exhaust manifold and the cooling jackets in the cylinder head casting according to the invention,

FIG. 11 is a perspective view showing the cores used for providing the lower cooling jacket, with the various chambers into which it is divided,

FIG. 12 is a perspective view showing the core used for providing the upper cooling jacket with portions defining transverse chambers separate from each other, and

FIG. 13 is a further exploded perspective view of the cores for providing lower and upper cooling jackets with the indication of the paths followed by the cooling fluid in the passages provided by means of such cores.

### DETAILED DESCRIPTION OF A PREFERRED EMBODIMENT

The illustrated example refers to the case of a cylinder head of a turbocharged internal combustion engine, with four in-line cylinders. It is however clear that the present invention may be applied to any other type of engine, with any number of cylinders and both in cases where a turbo-supercharger unit is provided for and in cases where such unit is not provided for.

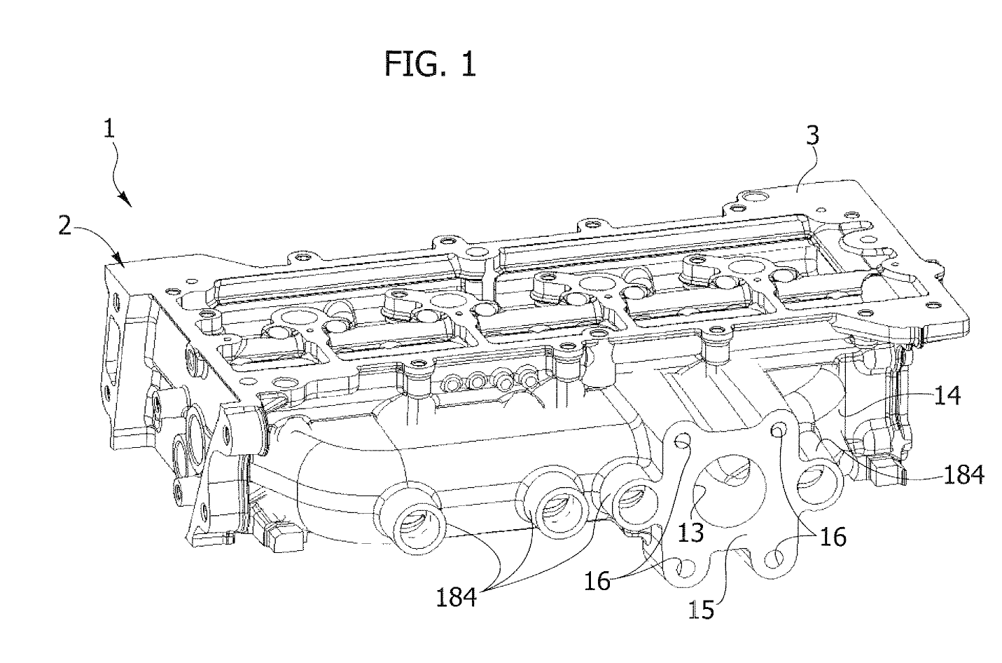

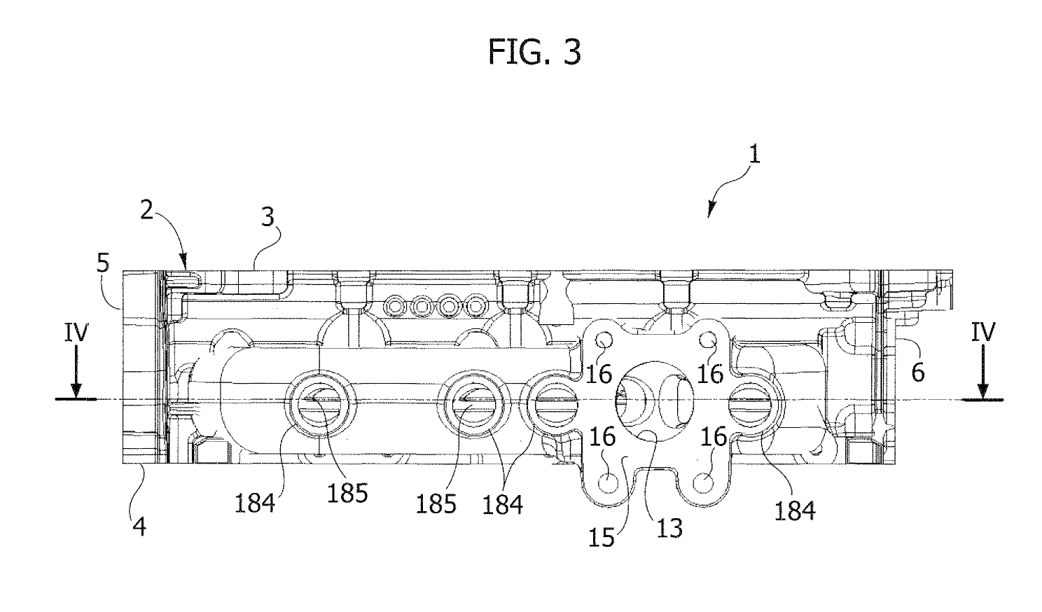

Referring to FIGS. 1-9, number 1 indicates a cylinder head according to the invention in its entirety, having a single aluminium body 2 with an upper face 3, a lower face 4 (see FIG. 3) a first end face 5 and a second end face 6.

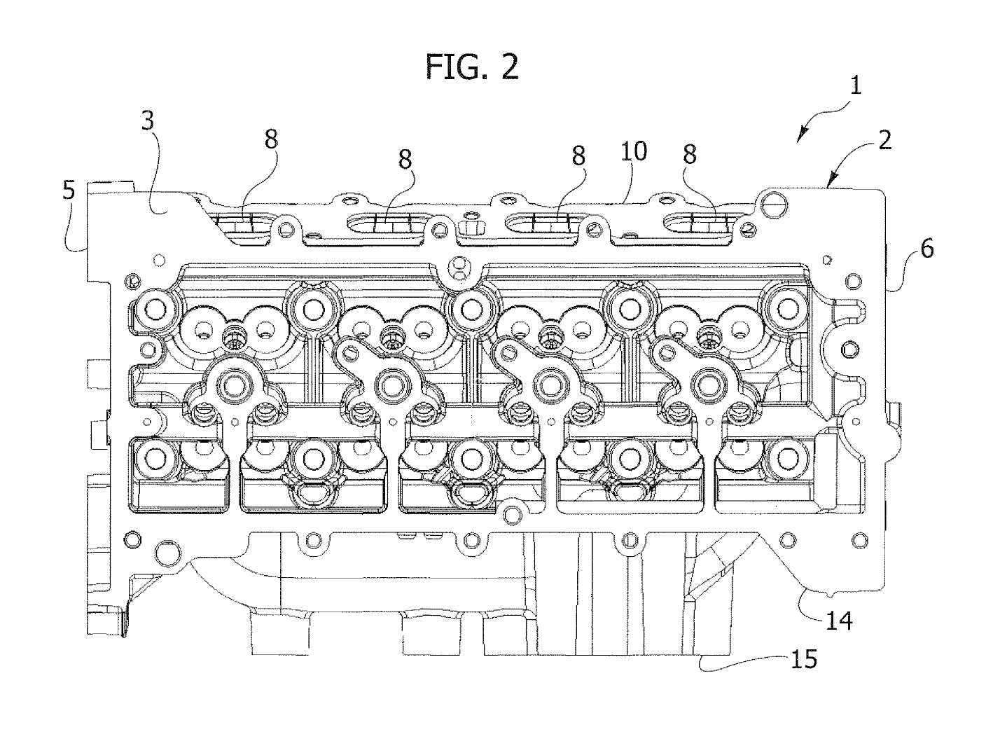

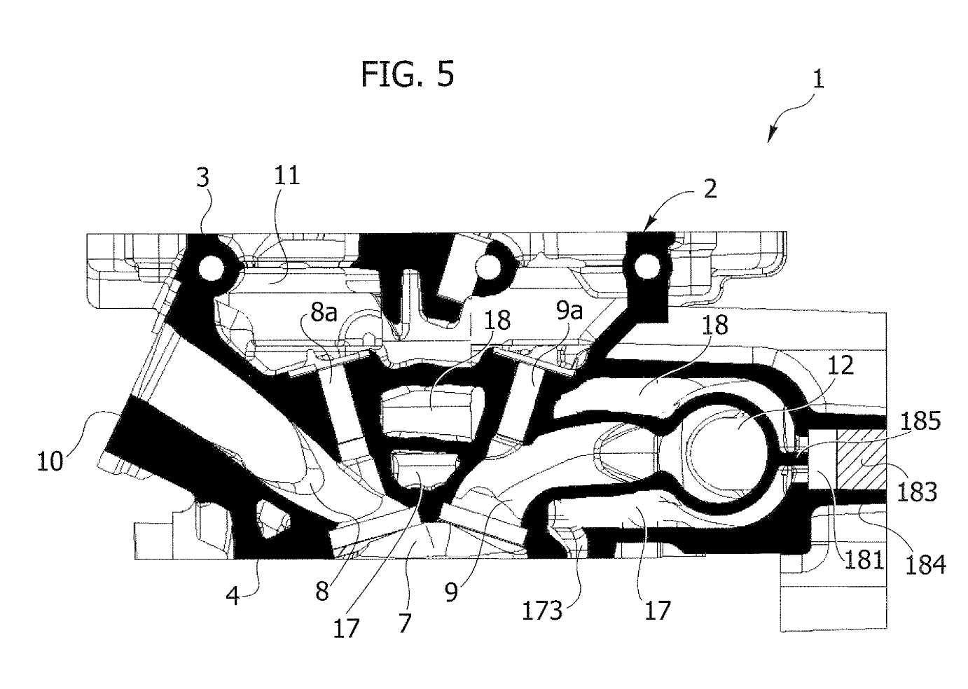

Cavities 7 (see FIG. 5, 6) defining the combustion chambers associated to the cylinders of the engine are formed in the lower face 4 of the cylinder head. The illustrated example refers to the case of an engine having two intake valves and two exhaust valves for each engine cylinder. Therefore, two intake conduits 8 and two exhaust conduits 9 (see FIG. 5) are formed by casting in the body 2 of the cylinder head 1. The intake conduits 8 end in a longitudinal side wall 10 of the head (see FIGS. 2, 5). FIG. 5, also shows the through holes 8a and 9a ending—at the upper part—on the upper face 3 of the head and—at the lower part—in the respective intake and exhaust passages 8, 9, intended to receive the intake and exhaust valves. A cavity 11 intended to house one or more camshafts and the respective tappets for the actuation of the intake and exhaust valves is provided in the upper face of the head, according to the conventional art.

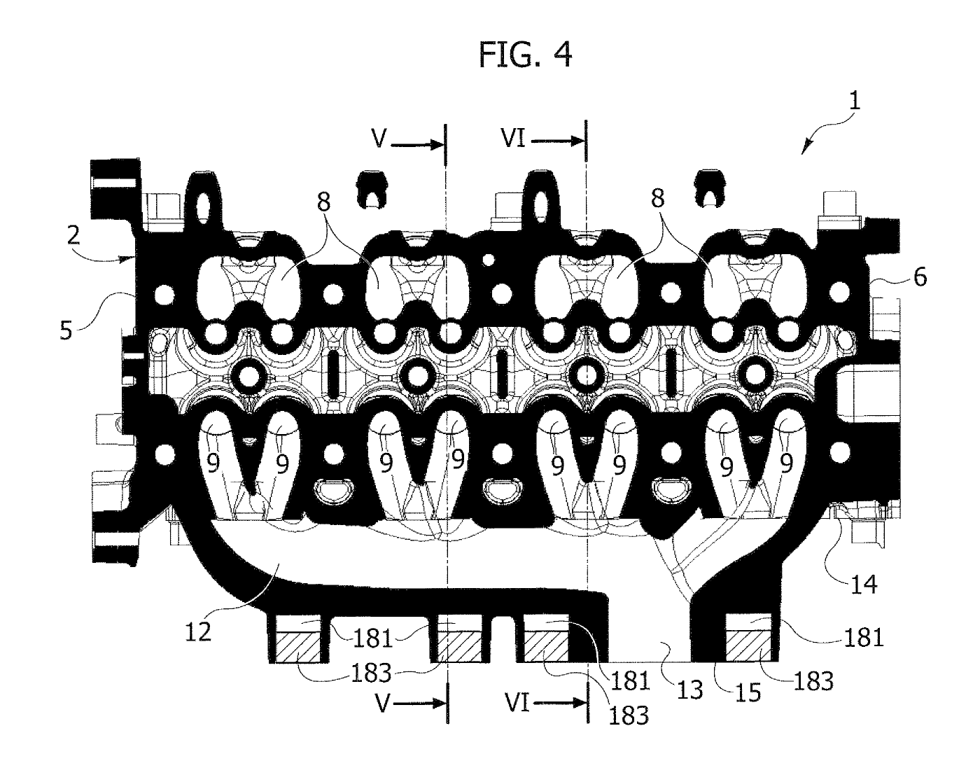

As clearly observable in FIG. 4, the engine exhaust manifold is also provided in the cylinder head 1 in a single cast piece, comprising a single passage 12, extending substantially in the longitudinal direction of the head, into which all exhaust conduits 9 converge, such passage in turn communicating with a single outlet common for all exhaust conduits 9, indicated with reference number 13 (FIG. 4) and ending in a longitudinal lateral face 14 of the cylinder head, at a planar facet 15 (FIG. 1) bearing holes 16 for the engagement of screws for fixing the turbocharger unit.

As observable in FIG. 1, in the case of the illustrated example, the portion of the head in which the exhaust manifold is integrated defines a part projecting from the longitudinal lateral face 14.

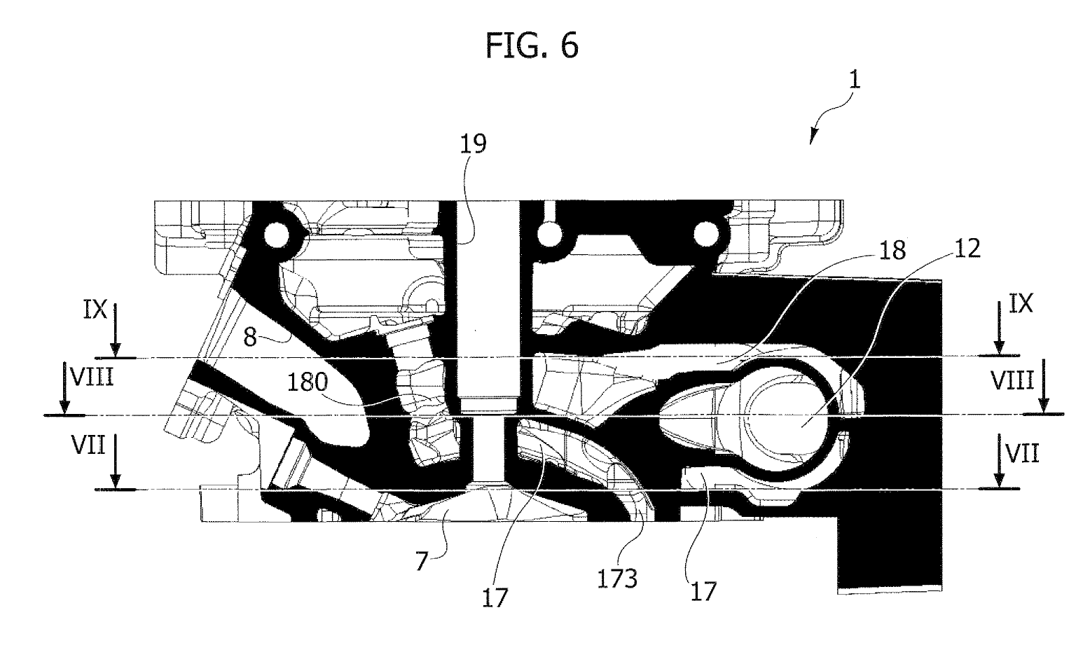

Still referring to FIGS. 5, 6, also formed by casting in the body of the cylinder head 1 are lower and upper cooling jackets 17, 18, described in detail hereinafter, for cooling the head and in particular the exhaust manifold provided in the head. As observable in FIGS. 4-6, the passages defining the exhaust manifold have the central axes thereof substantially in the same plane parallel to the general planes of the lower face and the upper face of the head. Gas passage conduits may also be positioned having non-coplanar axes. The lower and upper cooling jackets 17, 18 are extended substantially below and above the abovementioned passages defining the exhaust manifold. FIG. 6 also shows one of the passages 19 provided in the head to allow mounting spark plugs associated to the various cylinders of the engine.

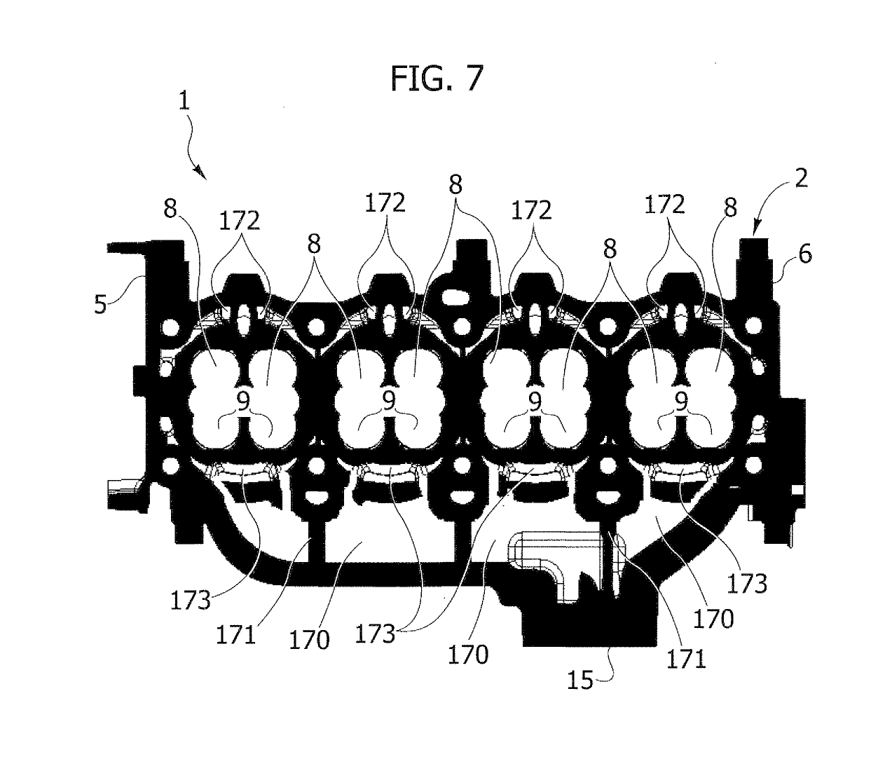

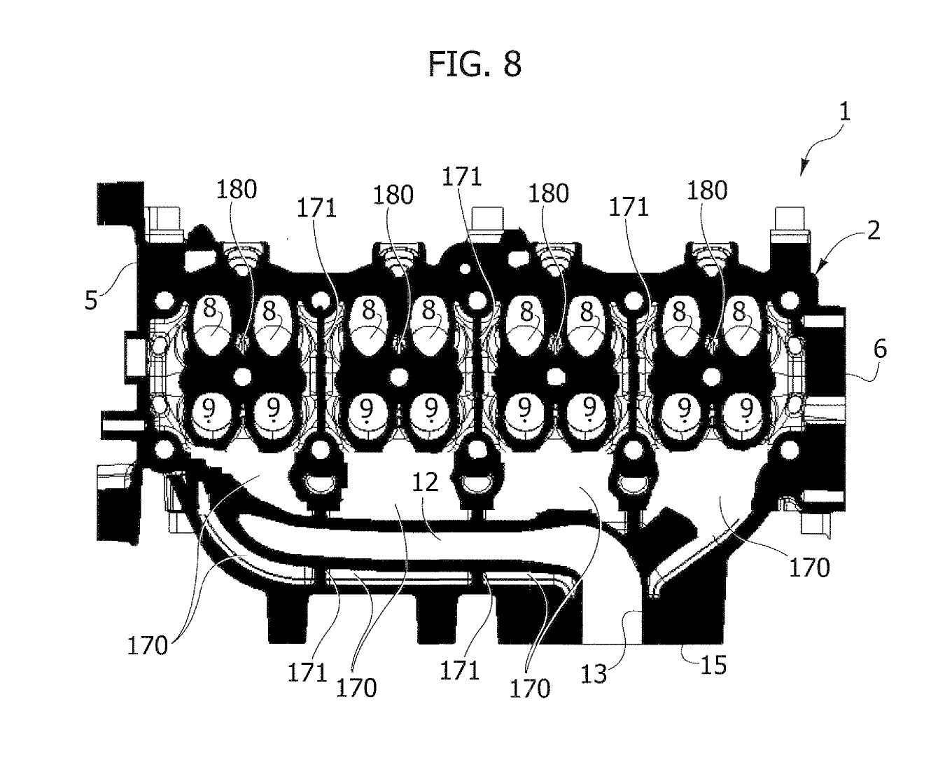

FIGS. 7-9 show sections of the head in horizontal planes corresponding to lines VII, VIII and IX of FIG. 6, i.e. substantially at the height of the lower cooling jacket, at the height of the exhaust manifold and at the height of the upper cooling jacket. Referring to FIG. 7, it is clearly observable that the lower cooling jacket 17 is actually longitudinally divided into four separate transverse chambers 170 by transverse partitions 171 provided in a single piece with the cylinder head. The transverse chambers 170 of the lower cooling jacket are intended to receive the cooling fluid from the circuit provided in the engine block by means of passages 172, 173 distributed over the entire length of the cylinder head (see FIG. 7), provided starting from the lower face of the head respectively adjacent to the intake side and the exhaust side (also see FIGS. 5, 6) of the combustion chambers 7. Therefore the cooling fluid coming from the block is forced to pass through the lower cooling jacket 17 traversing the four transverse chambers 170 parallel according to the directions orthogonal to the longitudinal direction of the head. The cooling fluid passes from the lower cooling jacket 17 to the upper cooling jacket 18 through passages 180 (FIG. 8, 9 and FIG. 6) and 181 (FIG. 4).

Referring to FIGS. 6 and 8, 9, the communication passages 180 are each provided adjacent to a respective combustion chamber 7 between the two intake conduits 8. Referring to FIGS. 4, 5, the passages 181 are defined by closure elements 183 which obstruct the tubular appendages 184 formed by casting with the cylinder head. Particularly referring to FIG. 5, a horizontal septum 185 separates the lower jacket from the upper jacket at the longitudinal centreline plane of the manifold 12, on the outer side of the manifold. As observable in FIGS. 4, 5, the closure elements 183, constituted by threaded caps and screwed into the internally threaded surfaces of the tubular appendages 184, stop at a distance from the front edge of the partition 185, so as to define the communication passage 181 between the lower jacket 17 and the upper jacket 18. In FIGS. 1, 3 the closure elements 183 were omitted, thus the edge of the partition 185 is observable through the opening of each tubular appendage 184.

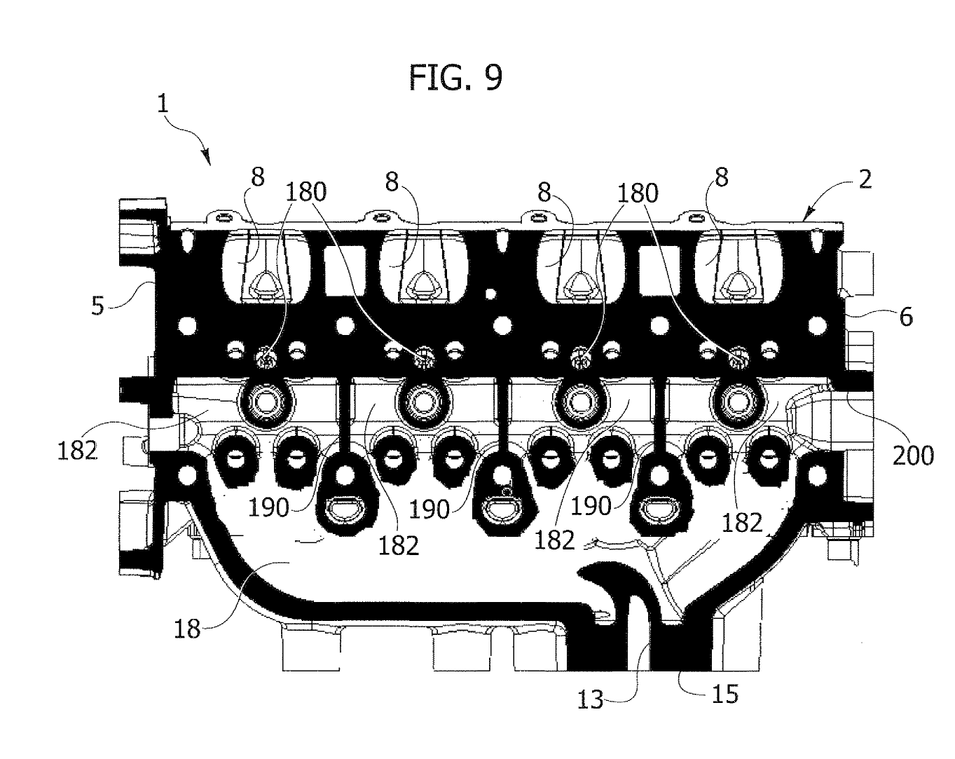

The cooling fluid may pass—through the passages 180 and 181—from the chambers 170 of the lower cooling jacket 17 to the upper cooling jacket 18. As clearly observable in FIG. 9, the upper cooling jacket 18 has a single longitudinal passage in the area located immediately above the manifold 12, while it is also divided into separate transverse chambers 182 on the opposite side of the head, by means of partitions 190. Also as clearly illustrated in FIG. 9, the upper cooling jacket 18 communicates—at the end face 6 of the cylinder head 1—with an outlet 200 for the cooling fluid from the head. The upper cooling jacket 18 communicates with such outlet 200 alone, hence the fluid traversing the transverse chambers 170 of the lower cooling jacket 17 is forced—in any case—to pass through the upper cooling jacket 18 before exiting from the head.

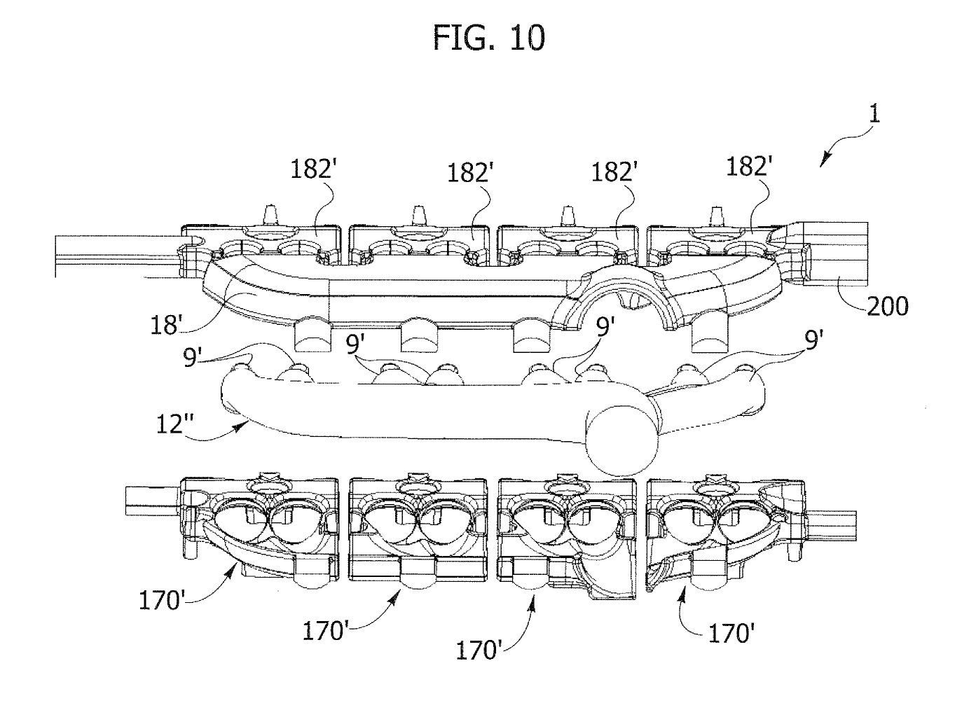

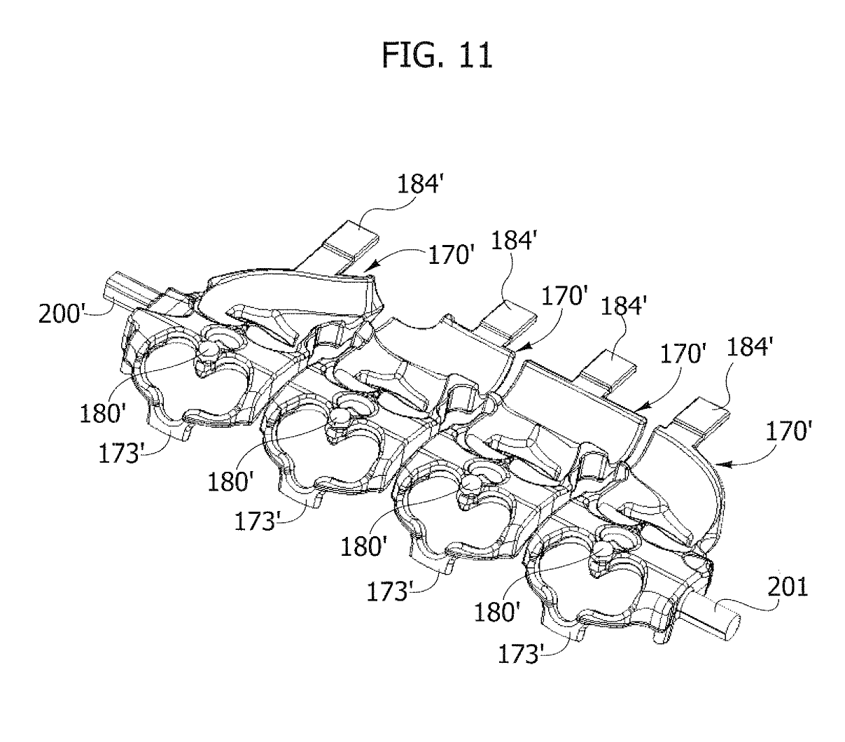

FIGS. 10-13 shows the cores used for providing the internal passages of the cylinder head during the casting of the head. The various portions of such cores correspond to the cavities and passages obtained in the finished head and they are indicated in FIGS. 10-13 using the same reference numbers used in FIGS. 1-9 to indicate such cavities and passages, with the addition of an apex. Therefore, FIG. 10 shows a core 12′ used to obtain the passages of the exhaust manifold, as well as the four cores 170′ used to obtain the separate transverse chambers 170 of the lower cooling jacket 17. Analogously, reference number 18′ indicates the core used to obtain the upper cooling jacket, with the separate portions 182′. Referring to FIG. 11, the parts indicated with reference number 173′ are those intended to provide the passages 173 for the inflow of the cooling liquid from the engine block, while the parts indicated with 180′ are intended to allow obtaining passages 180 for communication between the lower jacket and the upper jacket at the combustion chambers. Reference numbers 184′ indicate four appendages of the cores 170′ intended to provide a half of the internal cavity of the tubular appendages 184, at which the further communications between the lower jacket 17 and the upper jacket 18 are obtained.

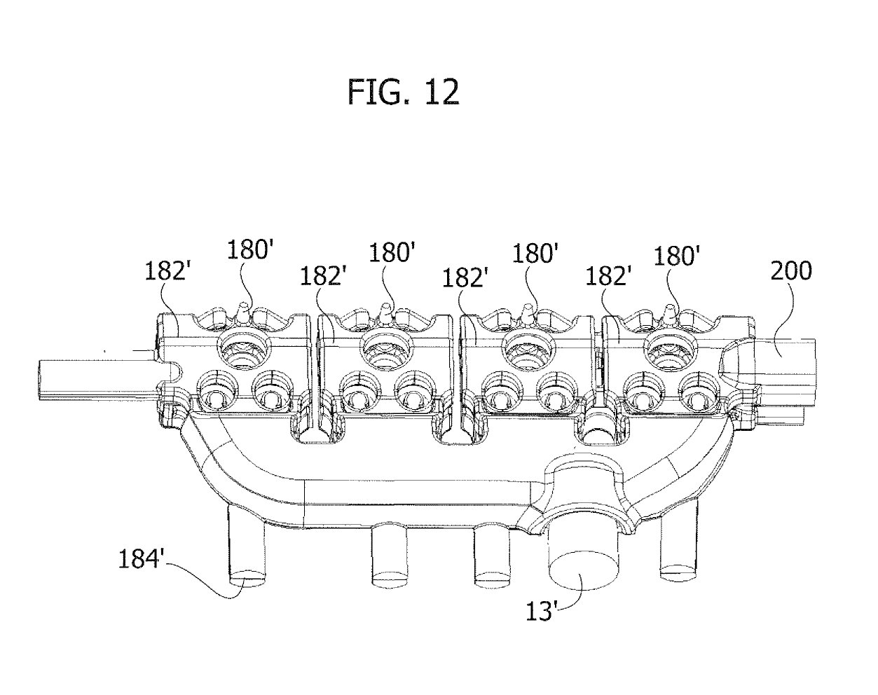

FIG. 12 shows the lower and upper cores overlapped with respect to each other. In such condition, the upper cores have the appendages 184′ thereof perfectly fitting with the appendages 184′ of the lower cores 170′ to define the internal cavities of the tubular appendages 184.

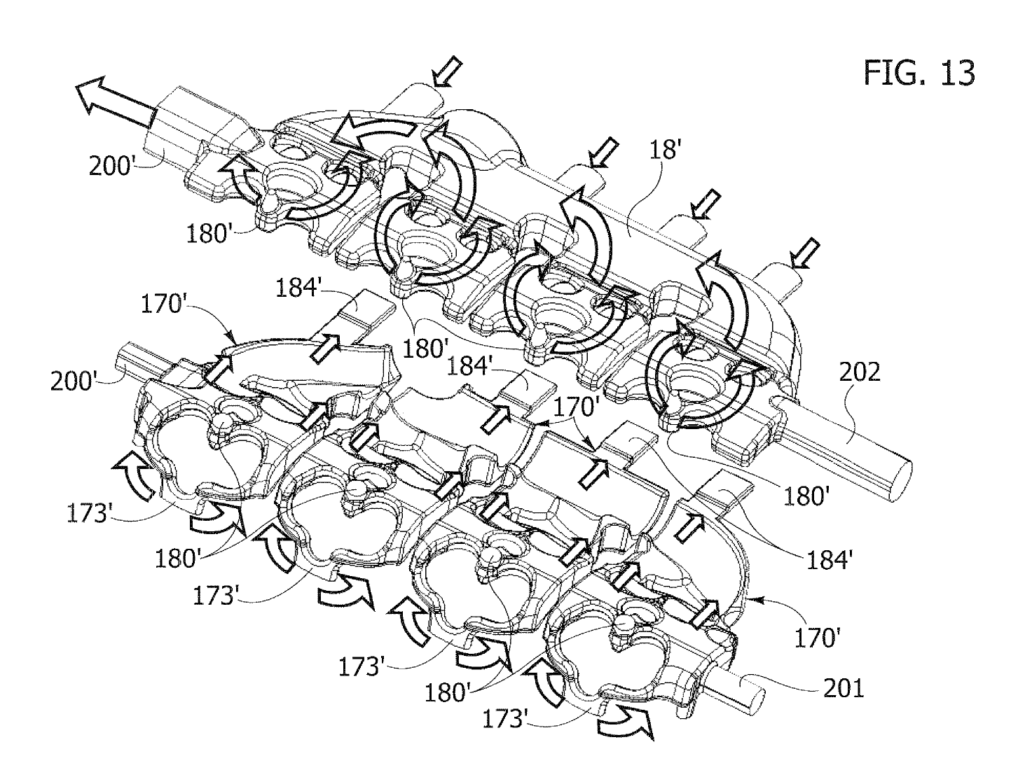

Lastly, in FIG. 13 the arrows show the circulation of the cooling liquid through the cooling jackets defined by the previously described cores. Once again, it should be observed that in FIGS. 10-13, a tang 201 and a tang 202 part of the upper and lower cores are not used to define cores in the head but solely as supports for the cores during casting, such tangs remaining outside the mould cavity.

As apparent from the preceding description, an essential characteristic of the cylinder head according to the invention lies in the fact that at least one between the lower cooling jacket and the upper cooling jacket is divided longitudinally into transverse chambers separated from each other, so that the cooling fluid is forced to pass through such transverse chambers parallel, according to directions transverse with respect to the longitudinal direction of the head.

In the preferred embodiment, separation into transverse chambers is realised for the lower cooling jacket, as well as, at least partly, for the upper cooling jacket. Furthermore, still in the embodiment described herein, the lower cooling jacket receives cooling fluid from the block through a plurality of openings distributed over the entire longitudinal dimension of the head. Still in such preferred embodiment, only the upper cooling jacket communicates with the outlet 200 for the cooling fluid from the head, so that the entire flow of the cooling fluid passing through the lower cooling jacket must also traverse the upper cooling jacket before exiting from the head.

The abovementioned characteristics allow obtaining an ideal cooling of the head and in particular a substantial cooling uniformity of the various portions of the head, and in particular of the various portions of the exhaust manifold, associated to the cylinders of the engine, with an ideal flow velocity of the fluid.

Obviously, without prejudice to the principles of the invention, the construction details and the embodiments may be widely varied with respect to what has been described and illustrated purely by way of example without thereby departing from the scope of protection of the present invention.

For example, the outlet 200 could be positioned in any area of the upper jacket 18, even for example on the same side of the cylinder head from which the exhaust gases exit, in an intermediate area between the two ends of the head and above the outlet of the gases.

1. Cylinder head for an internal combustion engine, having:
a body with an upper face, a lower face, two end faces, and two lateral faces,
at least one lower cooling jacket and at least one upper cooling jacket provided in the body of the head substantially below and above passages defining the exhaust manifold,
wherein at least one between said lower cooling jacket and said upper cooling jacket is divided in the longitudinal direction of the head into a plurality of separate transverse chambers, by means of a plurality of partitions provided in a single cast piece with the head and extending transversely with respect to the longitudinal direction of the head, so that—during the operation of the engine—the cooling fluid is forced to flow in parallel through said transverse chambers according to the orthogonal direction to the longitudinal direction of the head,
said cylinder head being characterised in that:
said body integrates, in a single cast piece, the engine exhaust manifold,
said exhaust manifold is defined by a plurality of passages for the exhaust gases provided in the body of the head, all said passages converging in a common outlet, ending in a lateral face of the head,
the lower cooling jacket is divided longitudinally into the above-mentioned separate transverse chambers associated to the various cylinders of the engine, while the upper cooling jacket has a portion extending longitudinally over the entire extension of the head above the exhaust manifold, and communicating with separate transverse chambers located on the intake side of the head.

2. Cylinder head according to claim 1, wherein the separate transverse chambers defined in the lower cooling jacket communicate with respective openings ending in the lower face of the head and distributed over the entire length of the head, to allow the inflow of cooling fluid from the cooling circuit of the engine block.

3. Cylinder head according to claim 1, wherein the separate transverse chambers defined in the lower cooling jacket communicate with the upper cooling jacket through respective passages distributed over the entire length of the head and arranged adjacent to the axis of each engine cylinder and adjacent to the lateral faces of the head on which the outlet for the exhaust gases ends.

4. Cylinder head according to claim 1, wherein an outlet for the cooling fluid from the cylinder head solely communicating with the upper cooling jacket is provided.

5. Cylinder head according to claim 4, wherein the outlet is located at an end of the head.

6. Cylinder head according to claim 4, wherein the outlet is located on the same side of the cylinder head from which the exhaust gases exit, in an intermediate area between the two ends of the head and above the outlet of the gases.

7. Cylinder head according to claim 3, wherein the communication passages at the lateral face of the head on which the abovementioned common outlet for the exhaust gas ends, are defined by tubular appendages closed by means of closure elements constituted by separate elements with respect to the head which leave a communication passage between the lower jacket and upper jacket outside a horizontal partition which separates the lower and upper jacket on the outer side of the exhaust manifold.
